(19) United States
(12) Patent Application Publication
(10) Pub. No.: US 2018/0220634 A1
(43) Pub. Date: Aug. 9, 2018

(54) Alpha Frog Soft Plastic

(71) Applicant: Jo STARLING, Tuross Head, New South Wales (AU)

(72) Inventor: Jo STARLING, Tuross Head, New South Wales (AU)

(21) Appl. No.: 15/750,231

(22) PCT Filed: Jul. 8, 2016
(86) PCT No.: PCT/AU2016/050716

§ 371 Date: Feb. 5, 2018

(30) Foreign Application Priority Data
Aug. 8, 2015 (AU) 2015903177

(51) Int. Cl. A01K 85/01; A01K 85/02

(52) U.S. Cl. CPC A01K 85/01; A01K 85/02

(57) ABSTRACT

A soft plastic fishing lure designed to mimic a real frog that generates a strong sonic signature and a pulsating body action due to the hole in its belly, whether the lure retrieved across the surface or sub-surface, that increases a positive hook up rate when connected to a fishing line.

### FIELD OF THE INVENTION

The invention described below relates to the field of fishing, or more specifically to the realistic fishing lures that simulate swimming live baits.

### BACKGROUND OF THE INVENTION

Fishing is a popular sport or leisure activity where a person can attempt to catch a fish via use of a rod and reel, a handline, or methods which usually include some sort of line and a hook combination.

Bait selection is a very vital part of successful fishing as it is the bait that attracts the fish to the hook and therefore to the line of the person fishing (also known as an ‘angler’).

Traditional natural baits used in fishing are animals or plants that fish are known to eat. Anglers try to select the type of bait that suits the conditions they are fishing in. Water creatures such as bait fish species like white bait, prawns, squid or frogs are known to be creatures that specific carnivorous fish target to eat.

Whilst natural baits can be successful, there are many drawbacks that the angler can suffer by using them. The problems with these baits are: 1) The time needed to source the natural bait, especially if live bait is required; 2) The cost of buying natural bait from a store, or for the petrol used on a boat to source and catch the natural bait; 3) The limited nature of natural bait as you must hope that the amount of bait you have caught/bought will be enough to land you a fish; 4) The single strike nature of natural bait as a fish usually takes a presented natural bait with no second chance for the angler to use that bait again should they not be successful in hooking up a fish; and 5) The cleanup of mess and smells required in dealing with natural baits.

Artificial fishing lures have grown in popularity for these and many other reasons. Artificial fishing lures can be hard bodied (such as wood, metal or hard plastic lures) or soft bodied (such as soft plastics or rubber). Hard and soft lures are designed to mimic the look of swimming fish, or other creatures such as frogs that are natural baits for fish.

The challenge for hard bodied artificial fishing lures is to design them so that swim realistically in the water to successfully mimic the creature they are trying to imitate, given that they are constructed of rigid material.

Soft bodied lures more successfully mimic the movement and profile a natural bait fish or water creature and often realistically resemble the natural bait intended in various sizes, shapes, colours and the sound/pulses produced by their swimming action.

There are soft plastic lures that specifically resemble frogs so that various species such as bass, cod, mulloway, snapper, barramundi, catfish and saratoga, as well as many others, find them attractive to eat.

The limitations of existing frog shaped soft plastic lures on the market were that: 1) They are each designed to be retrieved at one speed, ie: to achieve optimum effect, the angler must find the perfect retrieve speed for each lure design; 2) The rigging options/hook setups were typically very snag proof, but the method of achieving this meant that the hook point was snug against the lure body, thus limiting hooking of a fish as well; 3) They could not be fished both weedless and with a jig head; 4) They cannot be fish both surface and sub-surface, especially within the one retrieve.

Therefore, what is needed is a soft plastic frog fishing lure that could remedy these problems and offer the angler a more varied and successful fishing experience by attracting more fish, through the whole water column available to the angler in each retrieve and successfully hooking up to a fish when it strikes a soft plastic frog.

### SUMMARY

The principal objective of the invention is to provide a soft plastic fishing lure in a shape suggestive of a frog (or other sea/water based creature) that incorporates a unique, hydrodynamic, original and realistic pulsating action in its design as well as deliver a unique sonic signature via the circular designed hole in the ‘stomach’, that is able to be fished both weedless and with a jig head at variable speeds which provides the option to the angler of adding additional scents to the lureusing the flaps on the underside to retain the scent. The body of the lure features hydro-dynamic strakes along the flanks to facilitate better movement through the water and contribute to the subtle bobbing action of the lure during retrieve.

The unique, original and pulsating action of the lure allows the angler to alter retrieval style from high-stick, fast or slow surface retrieval where the bait would be primarily on the surface, to a sub-surface retrieve where a slow, pulsing action would place the lure underneath the surface of the water, when desired.

This lure makes for more successful fishing due to it's subtle, pulsating body movement and more natural kicking/paddling leg action over other soft plastic frog lures, and therefore provides a much better representation of an edible, living frog to a fish, enticing it to strike aggressively at the body that houses an exposed hook point below the height of the lure back/top, which leads to more successful hook-ups.

The design of the circular stomach hole through the body of the lure in its shape, size and location generates a bubble trail and a pulsating action (caused by the flexing and contracting of the body and its belly hole when it's pulled through the water), that creates a unique sonic signature. This action and sonic signature has been proven to attract the attention of fish and make them follow the direction of the lure, as seen in other lure types such as popper lures. This invention relates to the design of the circular stomach hole, which adds this bubble trail and body pulse action to the sonic signature of a soft plastic frog lure as an attractant and bite stimulant. Being able to attract a fish to the soft plastic lure by both visual and aural means, whether on the surface or underwater is another reason the invention is able to make claims of more successful fishing for anglers.

The unique belly hole also allows the hook point to be exposed whilst keeping it below or level with the top of the lure body, making it weedless without minimising fish hooking potential.

The broad blunt face and the broad pointed face variants of the lure both provide that that the lure moves hydro-dynamically through water and at an optimum level. The broad pointed face variant minimises any lateral rolling motion if an angler decides that they want the lure to remain upright through the water.

The cutaway strakes in the body of the invention show that the lure is designed to enhance its sonic signature whilst also providing protection for any waxy scent gel applied to the lure by the angler.

The invention lure's kicking legs are also there to further entice fish, as it mimics the swimming action of a real frog moving in the water, whether it is above or below the surface.

This inventive lure can be fished in various ways because of the option to be fished in a weedless manner of rigging (which would minimise potential snags and false hook ups if fishing in waterways which have natural structure or weed beds). The option to also fish this lure with a weighted jig head makes this lure even more versatile, as it can be fished deep or shallow. In deeper water, this innovation has caught species that have never seen a frog, therefore demonstrating that the combination of subtle trailing leg motion and the pulsating body can mimic sea creatures such as squid and octopus.

The inventive lure has eyes coloured with Ultraviolet (UV) paint that assist both the angler in being able to see their lure and thus being able to both spot any strikes if fished on the surface, as well as the fish being able to see the lure from a greater distance underwater. By making the invention easy to spot from a greater distance underwater with the addition of UV pigment, this lure adds another element to its ability to attract attention from potential target fish.

The invention is made of durable soft plastic material which should allow the angler to re-rig the lure if it were to become dislodged for any reason. It should also allow the angler to reuse it after catching a fish if the material has not been damaged by any sharp teeth that a particular species of fish may have. The bulk at the nose is designed to allow the angler to re-rig the lure three to four times before the tail needs repair or replacement.

It is intended that the invention will be manufactured in different sizes, colours and nose shapes to allow anglers can target all different species and sizes of fish in all environments and locations.

### BRIEF DESCRIPTION OF THE DRAWINGS

FIG. 1 Is the top view of the fishing lure.

FIG. 2 Is the side view of the fishing lure.

FIG. 3 Is the side view of the narrow nosed and thicker hip joint variant of the fishing lure discussed in claim 2.

FIG. 4 Is the underside of the fishing lure.

FIG. 5 Is the top view of the fishing lure with cross sectional references shown.

FIG. 6 Is the top view of the fishing lure with cross sectional reference A-A.

FIG. 7 Is the top view of the fishing lure with cross-sectional reference B-B.

FIG. 8 Is the top view of the fishing lure with cross-sectional reference C-C.

### DETAILED DESCRIPTION

The following detailed description of the invention such as any details, examples, embodiments etc as described are not limited to the embodiments set forth and as such the invention can be adapted to many numerous body shapes and sizes, nose shapes and sizes, leg length or thickness, stomach hole size or shape and fishing applications.

FIG. 1 Shows conceptually what the invention looks like when viewed from above. It shows the pulse hole at 1 which will generate sonic signature and pulsating action when being retrieved, and a recessed scoop 2 designed to expose the hook point of a wide gape worm hook when being rigged to fish in a weedless capacity. Curled legs that kick realistically in the water are at the rear of the body 3

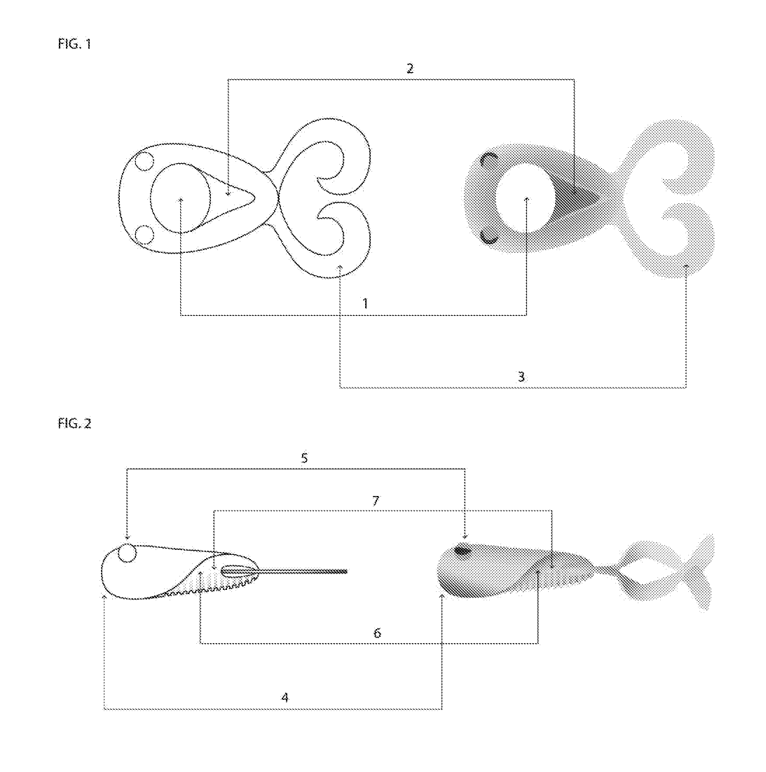

FIG. 2 Shows conceptually what the invention looks like when viewed on the side. It shows a broad blunt head design 4, bulging eyes 5 meant to be adorned with UV paint to appeal to the fish as well as an indicator for the angler, and hydrodynamic strakes 6 for optimal movement through water. Belly flaps 7 also follow a sympathetic curve to the strakes

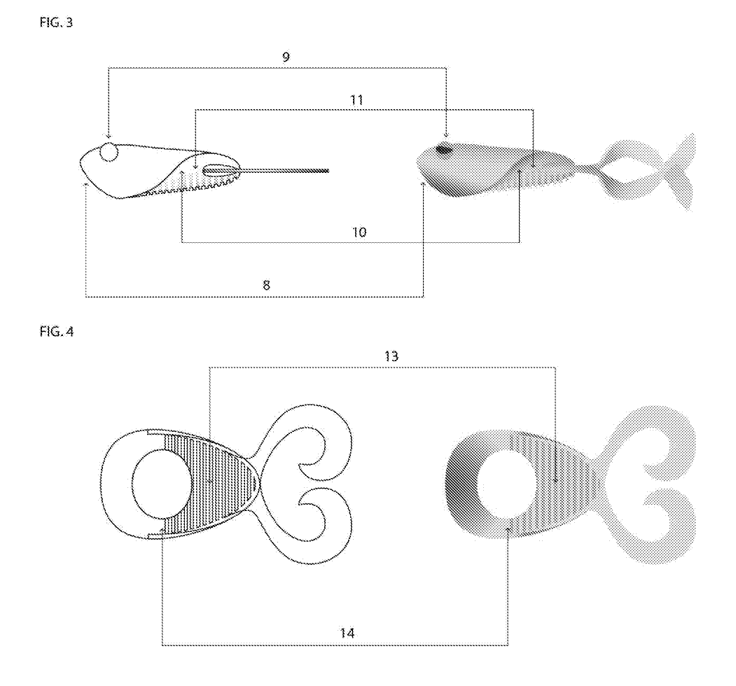

FIG. 3 Shows conceptually what another variation of invention looks like when viewed on the side. It shows a broad pointed head design 8, bulging eyes 9, meant to be adorned with UV paint to appeal to the fish as well as an indicator for the angler, and hydrodynamic strakes 10, for optimal movement through water. Belly flaps 11, also follow a sympathetic curve to the strakes and thickened hip joints 12 for heavy duty use.

FIG. 4 Shows conceptually what the invention looks like when viewed from below. It features belly flaps 13 on the back 60% of its stomach 14 in order to retain any artificial scent the angler wishes to use and for visual appeal.

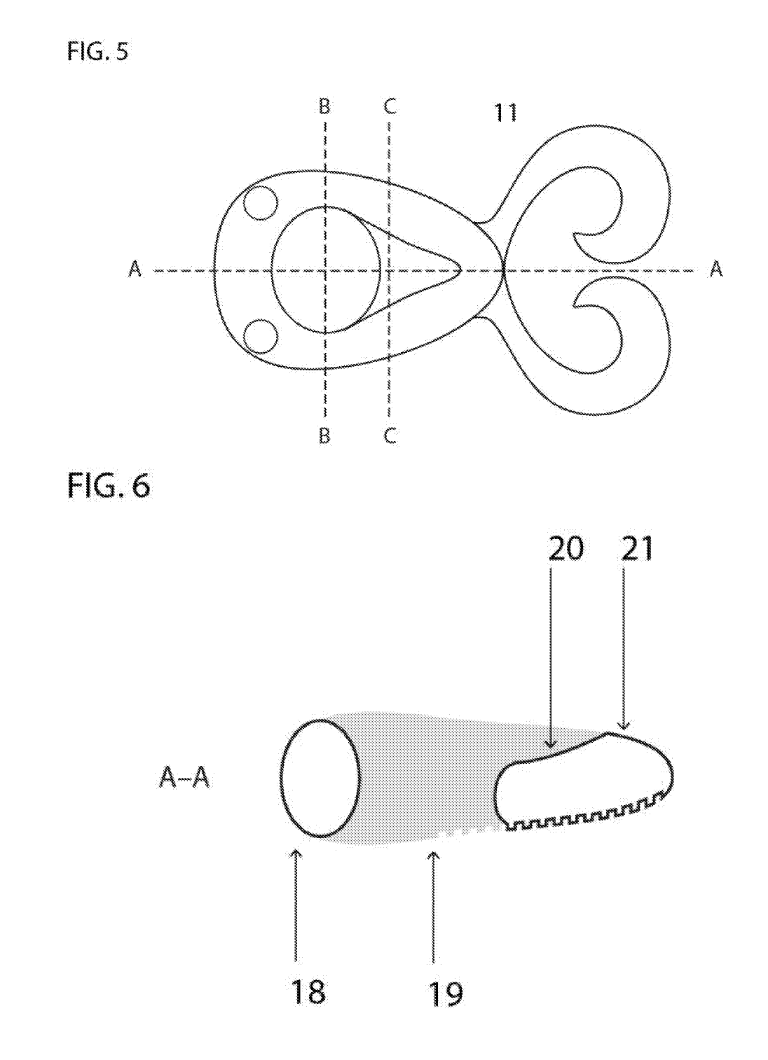

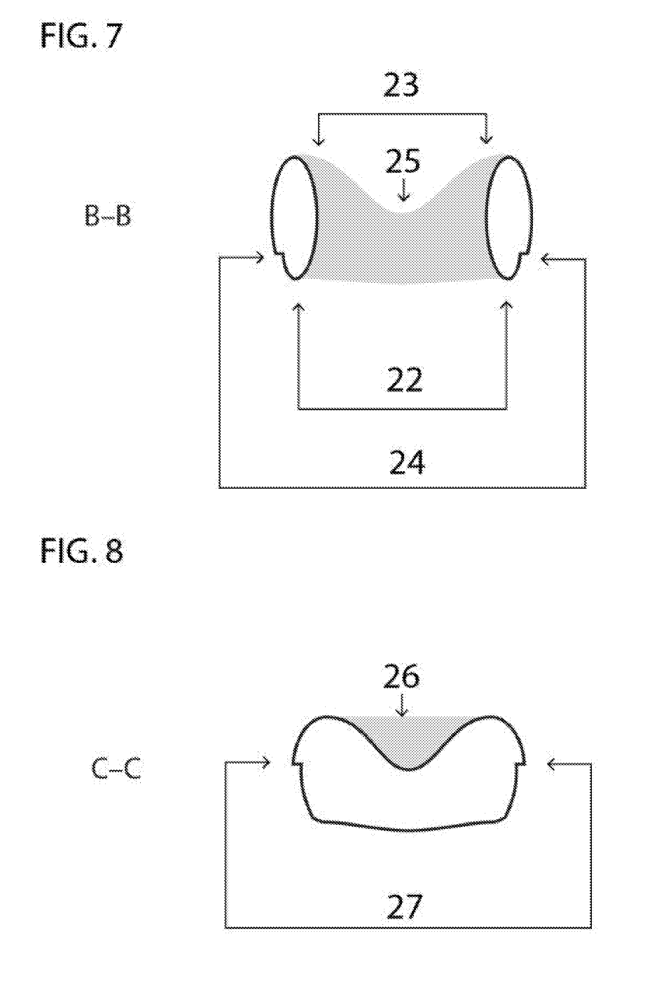

FIG. 5 Shows the cross-sectional sections 15 16 17 that will be referred to in FIG. 6, FIG. 7 AND FIG. 8 respectively.

FIG. 6 Shows conceptually what the cross-section A-A would comprise of. It shows the broad blunt head section 18, the tapered length of the body through the hole, 19, and the scoop at the back of the hole 20, leading up to the tail 21 showing ample soft plastic body to anchor a hook 20.

FIG. 7 Shows conceptually what cross-section B-B would comprise of. It shows the narrow walls 22 demonstrating the oval shape of the hole running widthways across the body 23. The strakes are shown low on each side 24, along with the start of the scoop at the rear of the hole 25.

FIG. 8 Shows conceptually what cross section C-C would comprise . It shows the soft plastic available at the back of the hole 26 where the weedless rigged hook or low set jig head would sit 26. The strakes are shown higher in their curve 27.

1. A soft plastic fishing lure designed to mimic a real frog that generates a strong sonic signature and a pulsating body action due to the hole in its belly, whether the lure retrieved across the surface or sub-surface, that increases a positive hook up rate when connected to a fishing line and comprising:
A moulded lure body with a broad face having a front and a tail segment fused together.
Soft plastic frog shaped lure body with a circular shaped convex hole in its belly region.
Recessed scoop that comes off the back of the circular shaped hole exposing the hook point of a wide gape worm hook.
Bulging Ultraviolet (also known as ‘UV’) eyes residing on the top of the lure.
Curled, flattish “legs” create a realistic paddling movement when dragged through water, are joined firmly to the rear of the body.
Hydrodynamic belly flaps on the back 60% of its convex stomach to retain any artificial scents.
Higher head section to protect the exposed hook from weeds in order to be fished weedless.
A broad, bluntface.

2. The artificial lure of claim 1 further comprising:
A tapered broad face nose
Thickened hip joints of the soft plastic lure for more heavy duty use
